(19) United States
(12) Patent Application Publication
(10) Pub. No.: US 2023/0271775 A1
(43) Pub. Date: Aug. 31, 2023

(54) A CONTAINER TRANSPORTATION SYSTEM

(71) Applicant: CF TECHNOLOGIES PTY LTD, Kew (AU)

(72) Inventors: Bruce ALLEN, Kew (AU); Philip Macgregor NORMAN, Kew (AU)

(21) Appl. No.: 18/014,734

(22) PCT Filed: Jun. 28, 2021
(86) PCT No.: PCT/AU2021/050682

§ 371 Date: Jan. 5, 2023

(30) Foreign Application Priority Data
Jul. 9, 2020 (AU) 2020902377

(51) Int. Cl. B65D 88/12; B65G 63/00; B66F 9/075; B66F 9/18

(52) U.S. Cl. CPC B65D 88/129; B65G 63/004; B66F 9/07572; B66F 9/18; B65G 2201/0235; B65D 2590/0083; B65G 2812/02069

(57) ABSTRACT

The invention relates to a container transportation system, such as a rail-based conveyance arrangement. The present invention provides a transportation unit for a container, such as a shipping container, the transportation unit having a wheel arrangement including one or more wheels for engaging a rail along which the container is conveyable, the one or more wheels being locatable at a side of the container; wherein said unit is detachably mounted to the container.

### FIELD OF THE INVENTION

The invention relates to a container transportation system.

### BACKGROUND

At existing shipping container docks, the scheduling and coordination of container movements between the ship and a distribution hub require space for containers, precise timing and accurate execution of transport. Many of these existing docks work to a capacity created by a number of these elements. Delays of any one of these elements (e.g. delays relating to rail, truck transport, customs inspections, or insufficient space for containers) lead to queuing of ships at the port. Therefore, any interruption to the schedule is costly. Increasing the storage space for containers may alleviate some of these delays, but would lead to additional scheduling issues. The frequency of truck movements and the stacking of containers create traffic congestion, potential safety and pollution issues.

There is a need for an improved transportation system for containers.

Accordingly, it is desired to address one or more of the above or at least provide a useful alternative.

### SUMMARY OF THE INVENTION

In a first aspect, the present invention is directed to a transportation unit for a container, the transportation unit having: a wheel arrangement including one or more wheels for engaging a rail along which the container is conveyable, the one or more wheels being locatable at a side of the container; wherein said unit is detachably mounted to the container.

The transportation unit can be particular adapted for use in a transportation system for containers comprising at least one rail-based conveyance arrangement for conveying containers. A rail-based conveyance arrangement has conveyance flow-paths defined by providing rails which can be engaged to transport an item along the flow-path. Herein there are references to a “pipe arrangement”. These references should be understood as referring to a rail-based conveyance arrangement. The “pipe” of the arrangement can be understood as defining the volume through which the container can pass during transport. Accordingly, references to a “pipe” can be understood as references to conveyance flow-paths. The “pipe” may not be a volume enclosed by a pipe wall, although this may be used in some embodiments (see e.g. FIGS. 4A, 5 and 8). In some other embodiments, the conveyance flow-path may be physically delimited by a partial pipe or a half-pipe (see e.g. FIGS. 3B-3D). Furthermore, the rail-based conveyance arrangement may comprise conveyance flow paths defined by two opposed walls on each of which a rail is mounted (see e.g. FIG. 9). Thus, for some embodiments of the transportation unit, said rail is a rail of a rail-based conveyance arrangement or said rail is a rail of a pipe arrangement.

The present invention may be particularly suitable for conveying shipping containers, but is not limited thereto. The skilled person will appreciate, in the light of the present disclosure, that the present invention may be adapted to containers of various types and dimensions. References to “shipping containers” include intermodal shipping containers compliant with relevant national and international standards, including as prescribed by the International Standards Organization (ISO) and Standards Australia, which include ISO 6346:1995, ISO 668:2020 and/or ISO 1496-1:2013. The contents of each of ISO 6346:1995, ISO 668:2020 and ISO 1496-1:2013 are incorporated herein by reference. Shipping containers may include: “dry freight” or “general purpose” containers; ISO-code 20-foot containers; ISO-code 40-foot containers; “High Cube” containers, including 48-foot containers and 53-foot containers; Bicon, Tricon and Quadcon containers (which correspond with ISO 668 standard sizes 1D, 1E and 1F respectively); pallet wide containers; and 60-foot (18.29 m) intermodal containers, recently introduced in North America.

In some embodiments, the container may be an overweight and/or oversize container, relative to the ISO 668:2020 standard, such as a container for transporting heavy machinery.

In some embodiments of the transportation unit, the wheel arrangement includes one or more first wheels that are attachable to a first sidewall of the container and one or more second wheels that are attachable to a second opposite sidewall of the container. The one or more first wheels and the one or more second wheels may be respectively mounted at or near a mid-height of the container. The transportation unit may comprise two first wheels that are attachable to the first sidewall of the container and two second wheels that are attachable to the second opposite sidewall of the container.

The transportation unit may have gantry-engaging portions that are engageable by engaging portions of a gantry system. The transportation unit may include a chassis on which the container to be conveyed is located, and arms extending from opposite sides of the chassis, the wheel arrangement being mounted to the arms, and the arms being pivotable inward relative to the chassis as the container is being located on the chassis so as to clamp the container between the arms of the chassis. The arm portions of the transportation unit may have one or more rings (or apertures) that are engageable by a hook portion of the gantry system. Alternatively or additionally, gantry-engaging portions may be provided along a length of each arm portion or on the chassis of the transportation unit. In some embodiments, one or more arms on each side of the chassis comprise gantry-engaging portions that are engageable by engaging portions of a gantry system for carrying the transportation unit. In some of these embodiments, one or more arms on each side of the chassis comprise a hook-shaped portion configured to be engageable by engaging portions of a gantry system for carrying the transportation unit.

In some embodiments, the transportation unit comprises a motor arrangement for driving said one or more wheels; and one or more foot portions electrically connected to the motor arrangement, said one or more foot portions being configured to contact an elongate power supply track to supply power to the motor arrangement. In some of these embodiments, one or more arms on each side of the chassis comprise a gantry-engaging portion (e.g. a hook-shaped portion) configured to be engageable by engaging portions of a gantry system for carrying the transportation unit, each of said one or more foot portions being connected to one of said gantry-engaging portions; wherein each gantry-engaging portion connected to one of said one or more foot portions is configured: to raise when engaged by the engaging portions and thereby move the foot portion connected thereto into a stowed configuration, wherein in the stowed position the foot portion is disengaged from the elongate power supply track; and to lower when disengaged from the engaging portions and thereby move the foot portion connected thereto into a deployed configuration for contacting the elongate power supply track.

In a second aspect, the present invention provides a transportation system for containers (such as shipping containers), the system comprising: at least one rail-based conveyance arrangement for conveying containers, said arrangement having rails and being adapted or configured to engage a transportation unit according to the present invention, said arrangement being adapted or configured to allow a container to pass therethrough. In some embodiments, the rail-based conveyance arrangement is a pipe arrangement. The pipe arrangement may include: a pipe having a width, and rails on which the transportation unit for conveying the container is mounted, each rail being positioned on opposite sides of the pipe wherein a distance between the rails substantially corresponds to the width of the pipe. The pipe arrangement may include a cylindrical pipe.

In some embodiments, the rail-based conveyance arrangement includes a half-pipe or partial pipe.

In some embodiments, the rails are spaced apart from each other by at least 4.5 m, such as by at least about 4.8 m.

When the container is located in the transportation unit and within the rail-based conveyance arrangement, there may be a clearance of at least about 20 cm from sidewall portions of said arrangement to the container. In some embodiments, the clearance may be 30 cm. The clearance may be measured from the narrowest gap between the structure of the rail-based conveyance arrangement. For example, when the rail-based conveyance arrangement includes rails in a cylindrical pipe, the clearance may be measured from the top corner of the container to the pipe portion. In some of the embodiments in which the rail-based conveyance arrangement includes rails in a cylindrical pipe, the critical clearance can be the when the container on a transportation unit is passing through the cylindrical pipe with the minimum radius of curvature.

The rail-based conveyance arrangement may include a curved portion through which the container is passable, the curved portion having a radius of at least 70 m. The curved portion may have a radius of at least 90 m.

The rail-based conveyance arrangement may have at least two conveyance flow-paths that are parallel with each other. The rail-based conveyance arrangement may include one or more return conveyance flow-paths, or service flow-paths, for conveying transportation units for mounting to a container for transportation through one of the at least two conveyance flow-paths. The return flow-path(s) may be parallel with the at least two conveyance flow-paths. The return flow-path(s) may run the full length of the at least two conveyance flow-paths or may run a partial length of the at least two conveyance flow-paths.

The rail-based conveyance arrangement may include a first conveyance flow-path for a flow of containers in a first direction, and a second conveyance flow-path for a flow of containers in a second direction opposite to the first direction. Alternatively or additionally, the arrangement may include a conveyance flow-path for conveying containers at a first speed and another flow-path for conveying containers at a second speed. The rail-based conveyance arrangement may includes a service conveyance flow-path for conveying the transportation unit to another conveyance flow-path along which a container is to be conveyed by said transportation unit. As noted above, the rail-based conveyance arrangement may be a pipe arrangement and each flow-path may be defined by a pipe.

The rail-based conveyance arrangement may include a sloping portion for changing an elevation of the containers conveyed through the rail-based conveyance arrangement. The sloping portion may have a gradient of at least about 1%. For example, the gradient of the incline may be up to about 10%. In some embodiments, the rail-based conveyance arrangement includes a helix-shaped pathway.

The rail-based conveyance arrangement and the transportation unit may include a sensor arrangement for detecting or determining a location of the transportation unit within the rail-based conveyance arrangement. In some embodiments, the sensor arrangement can detect labelled or tagged points within the rail-based conveyance arrangement and can then determine the location of the transportation unit (including any container being conveyed by that transportation unit) within the rail-based conveyance arrangement. In some embodiments, the sensor arrangement includes one or more RFID tags and one or more RFID readers for reading the RFID tags. The RFID tags may be provided along a length of the rail-based conveyance arrangement and the RFID reader for reading the RFID tags may be provided on the transportation unit. In some embodiments, the RFID tags are spaced at regular intervals along the flow-paths to facilitate accurate determination of location of the transportation units. The RFID tags may be position-calibrated after installation.

The transportation system may include a power supply system for powering said transportation unit when said transportation unit is mounted to one of the containers for conveying the container through the rail-based conveyance arrangement. The power supply system may include an elongate track that spans a length of the rail-based conveyance arrangement. In some embodiments, the elongate track is located in the pipe arrangement at an elevation below the rails of the rail-based conveyance arrangement.

The transportation system may includes a first gantry for carrying a container to or from a platform and a second gantry for carrying a transportation unit that is mountable to the container. The transportation system may include a controller for aligning the first gantry and the second gantry with each other so as to mount the transportation unit onto the container or to unmount the transportation unit from the container. The controller may be configured to align the first and second gantries with the conveyance flow path in which the container is to be conveyed.

In a third aspect, the present invention provides a gantry system for a container transportation system in which containers are transported via a rail-based conveyance arrangement, the gantry system including: a first gantry for carrying one of the containers to or from a platform, a second gantry for carrying a transportation unit according the present invention, said transportation unit being detachably mountable to the container, and a controller for aligning the first gantry and the second gantry with each other so as to mount the transportation unit onto the container or to unmount the transportation unit from the container. In some embodiments, the controller is configured to align the first and second gantries with a conveyance flow-path of the rail-based conveyance arrangement in which the container is to be conveyed. The second gantry may be configured or adapted to pluck (or collect) the transportation unit from a service conveyance flow-path.

Disclosed herein is a transportation system for containers, the system comprising: at least one pipe arrangement for conveying containers, the pipe arrangement being adapted or configured to allow a container to pass therethrough.

The pipe arrangement may include: a pipe having a width, and rails on which the container to be conveyed is mounted, each rail being positioned on opposite sides of the pipe wherein a distance between the rails substantially corresponds to the width of the pipe.

The rails may be spaced apart from each other by at least 4.5 m. Preferably, the rails are spaced apart from each other by at least about 4.8 m.

The pipe arrangement may include a cylindrical pipe. The pipe arrangement may additionally or alternatively include a half-pipe or partial pipe.

When the container is located in the pipe arrangement, there may be a clearance of at least about 30 cm from the sidewall portions of the pipe to the container. Preferably, the clearance is at least about 20 cm. The clearance is measured from a top of the container to the pipe portion.

The pipe arrangement may include a curved portion through which the container is passable, the curved portion having a radius of at least 70 m. Preferably, the curved portion has a radius of at least 90 m.

The pipe arrangement preferably includes at least two pipes that are parallel with each other. The pipe arrangement may include one or more return pipes, or service pipes, for conveying transportation units for mounting to a container for transportation through one of the at least two pipes. The return pipe(s) may be parallel with the at least two pipes. The return pipe(s) may run the full length of the at least two pipe or may run a partial length of the at least two pipes.

The pipe arrangement may include a first pipe for a flow of containers in a first direction, and a second pipe for a flow of containers in a second direction opposite to the first direction. The pipe arrangement may additionally include a pipe for conveying containers at a first speed and another pipe for conveying containers at a second speed.

The pipe arrangement preferably includes a return pipe for conveying a transportation unit that is mountable to a container to be conveyed in another pipe of the pipe arrangement. Two or more transportation units may be mounted to the container.

The pipe arrangement may include a sloping pipe portion for changing an elevation of the containers conveyed through the pipe arrangement. The sloping pipe portion may have a gradient of at least about 1%. In other examples, the gradient of the incline may be up to about 10%. The pipe arrangement may include a helix pathway. In one example, the helix pathway may be implemented within a cylindrical shell.

The pipe arrangement and container to be conveyed may include a sensor arrangement for detecting a location of the container within the pipe. The sensor arrangement preferably includes one or more RFID tags and one or more RFID readers for reading the RFID tags. The RFID tags are provided along a length of the pipe arrangement and the RFID reader for reading the RFID tags is provided on the transportation unit mounted to the container. Additionally or alternatively, the RFID unit may be provided on the container.

The transportation system may include a transportation unit that is mountable to the container to be conveyed through the pipe.

The transportation system may include a power supply system for powering a transportation unit mounted to one of the containers for conveying the container through the pipe. The power supply preferably includes an elongate track that spans a length of the pipe arrangement. The elongate track may be located at a lower wall portion of the pipe arrangement facing an underside of the container.

The transportation system may include a first gantry for carrying a container from a platform and a second gantry for carrying a transportation unit that is mountable to the container. The first gantry may be for carrying a container to a platform. The transportation system preferably includes a controller for aligning the first gantry and the second gantry with each other so as to mount the transportation unit onto the container. The controller may be configured to align the first gantry and the second gantry with each other so as to unmount the transportation unit from the container. The controller is preferably configured to align the first and second gantries with the pipe in which the container is to be, or is, conveyed.

A transportation unit for a container, the transportation unit having: a wheel arrangement including one or more wheels for engaging a rail of a pipe along which the container is conveyable, the one or more wheels being locatable at a side of the container.

The transportation unit is preferably detachably mounted to the container.

The wheel arrangement preferably includes a first wheel that is attachable to a first sidewall of the container and a second wheel that is attachable to a second opposite sidewall of the container. The first wheel and the second wheel are preferably respectively mounted at or near a mid-height of the container.

The transportation unit may include a chassis on which the container to be conveyed is located, and arms extending from opposite side of the chassis, the wheel arrangement being mounted to the arms, and the arms being pivotable inward relative to the chassis as the container is being located on the chassis so as to clamp the container between the arms of the chassis.

According to a further aspect of the present disclosure, there is provided a gantry system for a container transportation system in which containers are transported via a network of pipes, the gantry system including: a first gantry for carrying one of the container to or from a platform, a second gantry for carrying a transportation unit that is mountable to the container, and a controller for aligning the first gantry and the second gantry with each other so as to mount the transportation unit onto the container or to unmount the transportation unit from the container.

The controller may be configured to align the first and second gantries with the pipe in which the container is to be conveyed.

The second gantry may be configured or adapted to pluck the transportation unit from a return pipe.

### BRIEF DESCRIPTION OF THE DRAWINGS

The invention will now be described, by way of non-limiting example only, with reference to the accompanying drawings, in which:

FIG. 1 shows a transportation unit according to an embodiment of the present invention;

FIGS. 2A and 2B show a module of the transportation unit shown in FIG. 1 in different configurations;

FIGS. 3A to 3E show a container mounted on the transportation unit shown in FIG. 1 being arranged on a pipe arrangement of a transportation system;

FIGS. 4A to 4D show views of a container mounted on a pipe of a transportation system;

FIG. 5 shows a transportation system according to an embodiment of the present invention with a plurality of pipes;

FIGS. 6A and 6B show a transportation system according to an embodiment of the present invention;

FIGS. 7A and 7B show a transportation system according to an embodiment of the present invention;

FIGS. 8 and 9 show a pipe arrangement according to an embodiment of the present invention;

FIG. 10A to 10C shows a gantry component according to an embodiment of the present invention;

FIG. 11 shows a gantry system according to an embodiment of the present invention;

FIGS. 12A to 12E show a gantry system according to an embodiment of the present invention for locating a container in a pipe arrangement;

FIG. 13 shows a module of another embodiment of a transportation unit; and

FIG. 14 shows a gantry system according to an embodiment of the present invention.

### DETAILED DESCRIPTION

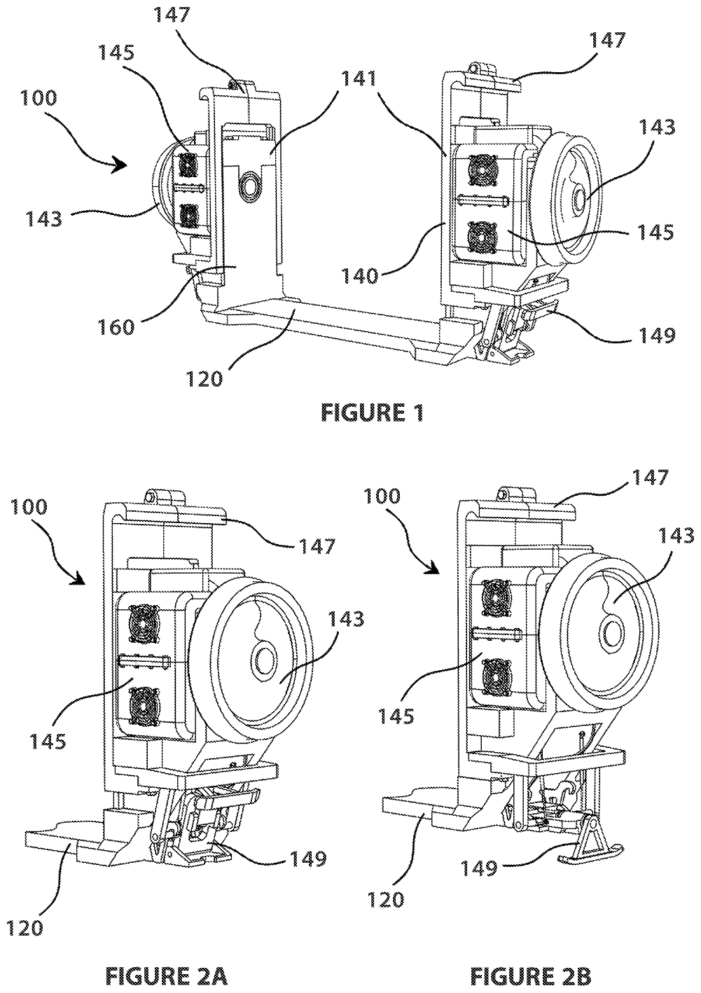

FIG. 1 illustrates a transportation unit 100 for a container according to an embodiment of the present invention. The transportation unit 100 is for conveying the container from a shipping dock to a storage facility for example. In other examples, the transportation unit is for conveying the container from a storage facility to a shipping dock, or for conveying the shipping container from one storage facility to another storage facility.

The transportation unit 100 is rail-engaging means that can be used to convey containers through a rail-based conveyance arrangement. Herein the rail-based conveyance arrangement is referred to as a “pipe arrangement”. Thus, the transportation unit 100 is pipe-engaging means that is locatable in a pipe arrangement of a container transportation system. The pipe arrangement is a network of pipes for facilitating transport of containers from one location to another. One or more transportation units 100 can be detachably provided on the containers to transform the containers into vehicles. In the preferred example, the transportation unit 100 mounts to a container for transporting the container through the network of pipes. The transportation unit 100 is detachably mounted to the container such that when a container is desired to be conveyed from one location to another, a gantry system mounts the container onto a transportation unit and locates the container with the transportation unit in a pipe of the pipe network to be conveyed to the second location.

In the present invention, the transportation unit is detachably mounted to the container. However, in other examples, the transportation unit may be an integral part of the container.

In some embodiments of the present invention, two transportation units are mounted to the container. A first one of the transportation units is a forward transportation unit that is mounted at or near a front of the container, while a second one of the transportation units is a rearward transportation unit mounted at or near a rear of the container. The two transportation units define a transportation assembly for that container. Each transportation unit of the transportation assembly is physically separate, and independent, from the other transportation unit of the same assembly. Accordingly, the transportation unit is an independent vehicle that can be controlled and managed without any connection to the container. This facilitates the management of the transportation units within the transportation system as the transportation units can be directed to arrive as required, individually or in the desired number for the container in question (e.g. as a pair). In some embodiments, the transportation units may be coupled in pairs when not attached to a container to assist steering along the rails for certain wheel configurations, such as embodiments having a single wheel on each side of the unit. Furthermore, as the transportation units can be shorter in length than the container, for example about one metre long in embodiments suitable for conveying shipping containers, the storage requirement for the transportation units can be much smaller than the requirements of other modes of conveying containers. In a variation, the transportation units of the transportation assembly may be linked together by a chassis portion.

In some embodiments, only one transportation unit may be mounted to each container or more than two transportation units may be mounted to each container. The maximum number of transportation units that can be mounted to each container can be limited by the size of the container. In the majority of applications, two transportation units may be sufficient. Three (or more) transportation units may be used to transport containers for which there are special load requirements, such as a load that is unusually heavy or a container carrying cargo that requires more steady or robust carriage than can be provided with two transportation units.

The transportation unit 100 has a chassis or a base portion 120 on which the container is mounted. The chassis 120 spans a width of the container to be conveyed. The transportation unit 100 further includes a pair of arms 140, 160 extending upwardly from opposite ends of the chassis 120. The chassis 120 with the upwardly extending arms 140, 160 form a substantially U-shape profile. The container when located on the chassis 120 would be between the two arms 140, 160. When the container is located on the chassis 120, one of the arms 140 would extend upwardly from the chassis on one side of the container, while the other arm 160 would extend upwardly from the arms extending from the chassis on an opposite side of the container. The arms 140, 160 do not extend beyond the height of the container. The arms are configured to clamp a container located therebetween. Each arm 140, 160 has a clamp portion 141 for clamping the container when located on the chassis 120. When the chassis 120 receives a container, the clamp portions 141 of the arms 140, 160 would clamp the container to securely locate the container relative to the transportation unit 100. The clamp portion 141 of each arm 140, 160 is pivotably mounted to the chassis 120 and pivot inwardly relative to the chassis when a load is applied to (e.g. a container located on) the chassis 120. In other examples, the container may be securely mounted on the transportation unit using other means. For example, the container may have a key portion that engages a keyhole in the transportation unit to lock the container in place.

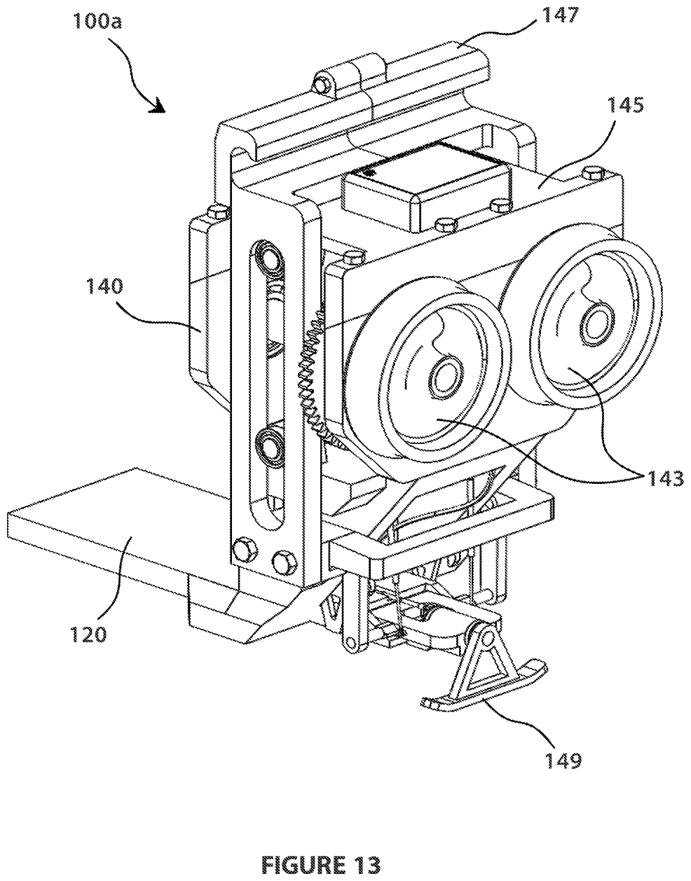

Each arm portion 140, 160 of the transportation unit has a wheel 143. The first arm 140 has one wheel 143 that is locatable at a first sidewall of the container, while the second arm 160 has one wheel 143 that is locatable at a second opposite sidewall of the container. The wheels 143 are located on sides of the container along a height of the container. The wheels 143 do not extend beyond the height of the container. The wheel 143 is located on a side of a container when mounted on the transportation unit 100. Each wheel is located substantially near a centre of the arm. An axis of rotation of the wheels 143 is located substantially near the centre of the arm. In addition, the axis of rotation of the wheels 143 passes through the container when mounted on the transportation unit 100. When a container is located on the chassis 120, the wheels 143 are located substantially near a mid-height of the container (that is, at or near half the height of the container). That is, the axis of rotation of the wheels 143 is near a mid-height of the container. The wheels (i.e. the axis of rotation of the wheels) may, in other examples, be located at at least a quarter of the height of the container or at at least a third of the height of the container. In other examples, each arm portion may contain two or more wheels that are longitudinally spaced apart from each other. An embodiment in which there is two wheels mounted to each arm is described further below with reference to FIG. 13. The positioning of the wheels at the sides of the container, along their height, provides the container mounted with the transportation assembly mounted thereon with a low centre of gravity, making the container with the transportation assembly less prone to tipping forces when turning. In addition, by positioning the wheels at the sides of the container, the real estate of the pipe can be efficiently utilised to provide a compact transportation system. In particular, a width dimension from the wheel of the transportation unit on one side of the container to the wheel on an opposite side is substantially equal to or less than a height dimension measured from a top of the container to a bottom of the chassis (i.e. the combined height of the container and the chassis). Both of these dimensions are less than a diameter of the pipe through which the container is conveyed.

In some other embodiments, the transportation unit 100a has two or more wheels on each arm. FIG. 13 illustrates a module of a transportation unit 100a. In particular, FIG. 13 shows a first arm 140 of an embodiment in which two wheels 143 are mounted to the arm 140. Like the transportation unit 100 shown in FIG. 1, the transportation unit 100a has a pair of arms (only 140 shown), with a mirrored structure for the second arm (not shown) so only the first arm 140 is illustrated here. The transportation unit 100a has a chassis or a base portion 120 on which the container is mounted. The chassis 120 spans a width of the container to be conveyed and, with the arms (only 140 shown), the chassis 120 forms a substantially U-shape profile. As with transportation unit 100, in transportation unit 100a the container when located on the chassis 120 would be between the two arms (only 140 shown). When the container is located on the chassis 120, one of the arms 140 would extend upwardly from the chassis on one side of the container, while the other arm would extend upwardly from the chassis on an opposite side of the container. In this embodiment, the arms (only 140 shown) do not extend beyond the height of the container. The arms are configured to clamp a container located therebetween.

Each arm (only 140 shown) of the transportation unit 100a has two wheels 143, as noted above. The first arm 140 has two wheels 143 that are locatable at a first sidewall of the container, while the second arm has one wheel 143 that is locatable at a second opposite sidewall of the container. The wheels 143 are located on sides of the container along a height of the container. The wheels 143 do not extend beyond the height of the container. The wheels 143 are located on a side of a container when the container is mounted on the transportation unit 100. The wheels 143 are located near to and on either side of a centre of the arm. When a container is located on the chassis 120, the wheels 143 are located substantially near a mid-height of the container (that is, at or near half the height of the container). That is, the axis of rotation of the wheels 143 is near a mid-height of the container. As described above, other wheel positions made be used in other embodiments.

Each transportation unit 100, 100a, shown in FIGS. 1 and 13, has a motor arrangement 145 for driving the wheels 143. Each arm 140, 160 of the transportation unit has a respective motor arrangement 145 for driving the wheel 143 that is mounted at that arm 140, 160. The motor arrangements 145 on the first and second arms are operated in unison or in concert with each other. For example, when the container is being conveyed along a straight section of the pipe arrangement, the motor arrangement on each side drives their respective wheel(s) at a similar speed. When the container is being conveyed through a curved section of the pipe arrangement, the motor arrangement on one side is driven at a different speed from the motor arrangement on the other side.

The free end of each arm 140, 160 has a hook-shaped portion 147. The hook-shaped portion 147 is engageable by a hook portion of a gantry system for carrying the transportation unit 100, 100a from a pipe or into a pipe. The hook-shaped portion 147 is adjustable relative to the rest of the arm 140, 160. In particular, when the hook portion of the gantry system engages the hook-shaped portion 147 of the transportation unit and lifts the unit upwards, the hook-shaped portion 147 moves upwards relative to the rest of the arm 140, 160. When the gantry system disengages the hook-shaped portion of the transportation unit, the hook shaped portion returns downwards to its normal position. The hook-shaped portions 147 are one example of a gantry-engaging portion of the transportation unit. In other examples, the transportation unit may have other gantry-engaging portions that are engageable by engaging portions of a gantry system. For example, the arm portions of the transportation unit have one or more rings (or apertures) that are engageable by a hook portion of the gantry system. In addition, the gantry-engaging portions may be provided along a length of each arm portion or on the chassis of the transportation unit.

The transportation unit 100, 100a also has foot portions 149, each of which is mounted to an arm 140, 160 of the transportation unit 100, 100a. In particular, each foot portion 149 is mounted at a lower end of the arm 140, 160. The foot portions 149 are electrically connected to the motor arrangement 145 on the arms 140, 160 such that when one of the foot portions 149 is in contact with a elongate power supply track, the motor arrangement 145 on both arms 140, 160 draws power from the elongate power supply track to drive the wheels 143. The foot portion of an arm is for contacting an elongate power supply track in the pipe to power the motor arrangements on the first and second arm to drive the wheels. The elongate power supply track would be located on each pipe of the pipe arrangement through which the container is conveyed. The elongate power supply track is located in the pipe arrangement at an elevation below the rail engaged by the wheel(s) 143. For use with the illustrated embodiments, the elongate power supply track is at an elevation below the level of the chassis 120 when the transportation unit 100, 101a is conveyed along the flow path. In some other embodiments, the elongate power supply track may be located at other positions within the conveyance flow-path. In a preferred example, the pipe has a pair of spaced apart elongate power supply tracks, each track for engagement by a foot portion 149 of a respective arm 140, 160 of the transportation unit 100, 100a. In this example, only one of the foot portions 149 is required to contact one of the tracks to supply power to the motor arrangement on both arms 140, 160 of the transportation unit 100, 100a to drive the wheels 143. The second track is provided for redundancy and for symmetry reasons. In particular, because one half of the pipe would be substantially a mirror image to the other half of the pipe, the transportation unit could be readily positioned in the pipe without needing to check the orientation of the transportation unit.

With reference to FIGS. 2A and 2B, the foot portion 149 on each arm 140 (only one arm shown) is adjustable between a stowed configuration and a deployed configuration. In the stowed configuration as shown in FIG. 2A, the foot portion 149 is tucked into the arm 140 so as to avoid the foot portion 149 from getting caught on the rail of the pipe onto which the wheel 143 on the respective arm 140 is to be located as the transportation unit 100 is raised from or lowered into the pipe. In the deployed configuration, as shown in FIG. 2B, the foot portion 149 is extended outwardly and downwardly from the arm 140 to contact the power supply track in the rail when the transportation unit 100 is located in the pipe. The foot portion 149 assumes the stowed configuration or the deployed depending on whether the hook-shaped portions 147 are in a raised position or in a lowered position. In particular, when the hook portion of the gantry system engages the hook-shaped portion 147 of the transportation unit 100 and carries the transportation unit 100, the hook-shaped portion 147 is lifted upwards relative to the rest of the arm 140 which causes the foot portion 149 to assume the stowed position. In this way, as the transportation unit is being lifted out of a pipe, the foot portion 149 would be tucked into the transportation unit 100 and prevented from getting caught on any rail components in the pipe. When the hook portion of the gantry system disengages the hook-shaped portion 147 of the transportation system 100, the hook-shaped portion 147 would return to its normal lowered position and the foot portion 149 would assume the deployed position. Importantly, the foot portion 149 would be safely deployed to contact the elongate power supply track in the pipe when the wheel 143 rests on the rail in the pipe. In other embodiments, the foot portions 149 for contacting the elongate power supply track may be fixed relative to the arms 140 of the transportation unit 100. For example, the smaller wheels may be used for the transportation unit so that the rails can be pushed further away from transportation unit without increasing the footprint size of the pipe in which the containers are conveyed. Alternatively, the foot portions can be located nearer to a middle of the transportation unit and could be located on an underside of the chassis.

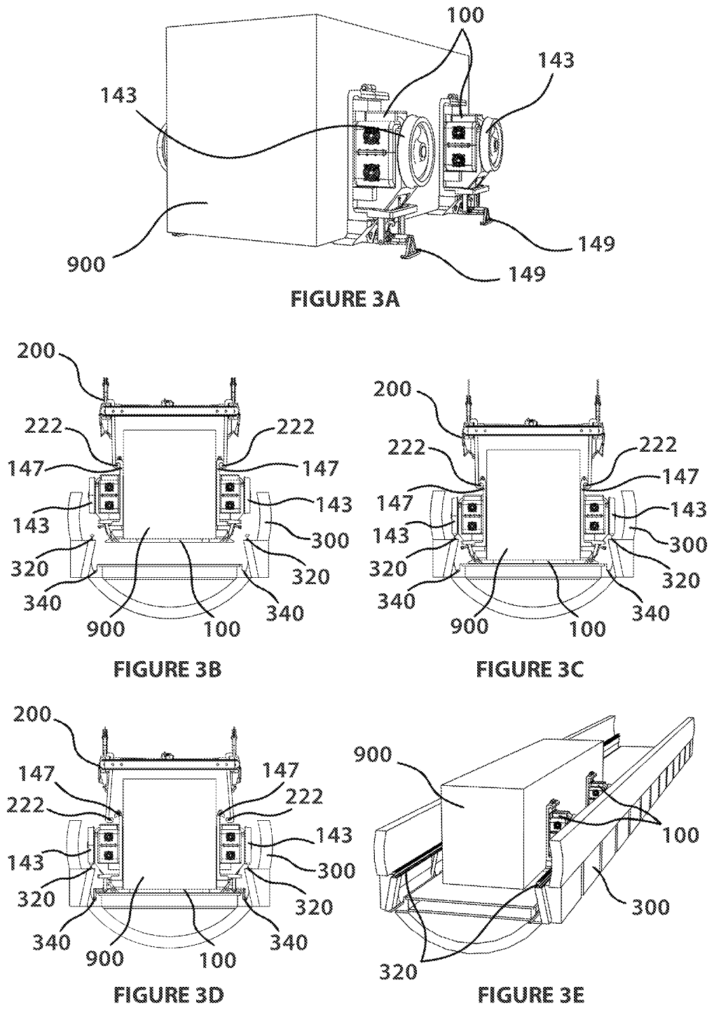

FIGS. 3A to 3E show a sequence of images for locating a container 900 with the transportation unit in a pipe. The pipe in which the container 900 is to be located is a partial pipe having a diameter that accommodates the container to be conveyed. The partial pipe may be a half-pipe. The pipe has a semi-cylindrical shape. In the transportation system according to preferred embodiments of the present invention, the half-pipes are utilised at loading and/or unloading locations. A pair of rails that extend the length of the track are provided within the pipe. The rails are spaced apart from each other by a distance that substantially corresponds to diameter (or width) of the pipe. For example the distance by which the rails are spaced apart from each other is at least about 85% the diameter (or width) of the pipe. Immediately below the rails are a pair of elongate power supply tracks that also extend the length of the pipe. The rails are spaced apart from each other by at least about 4.5 m. Preferably, the rails are spaced apart from each other by at least about 4.8 m. When the container is located in the pipe, there is a clearance of at least about 30 cm from the sidewall portions of the pipe to the container. Preferably, the clearance is at least about 20 cm.

As shown in FIG. 3A, and as previously described, two spaced apart transportation units 100 are mounted to a container 900. One of the transportation units 100 is a front transportation located near a front of the container 900, while the other transportation unit is a rear transportation unit located near a rear of the container 900. The two transportation units 100 form a transportation assembly. The distance between the two transportation units 100 can be adjusted depending on the size of the container 900 to be loaded into, or unloaded from, the pipe. In an example, the transportation units may be driven to a mounting site in the transportation system, from where the transportation units are collected by the gantry system, such that the transportation units at the mounting site have the appropriate spacing(s) therebetween for the container to be mounted thereon. In this regard, the motor arrangement of one or each of the transportation units may drive the respective transportation unit at the mounting site in a forward or rearward direction to adjust the spacing(s) between the transportation units depending on the size of the container to be mounted thereon. In this regard, in an example, a control system of the transportation system, which is in communication with the transportation units, is configured to receive information on a size of the container to be delivered through the pipe arrangement, call for one or more transportation units to the mounting site, and instruct the transportation unit(s) at the mounting site to move rearward or forward depending on the size of the container. In another example, the gantry system for locating the container onto the transportation units may adjust the spacing between the transportation units held by the hook portions of the gantry. In other examples, the spacing between the transportation units may be fixed (i.e. non-adjustable spacing). Having two spaced apart transportation units assists in balancing the container when located and conveyed through the pipe. In other examples, only one transportation unit may be mounted to each container. The transportation unit according to these other examples may have two or more spaced apart wheels on each arm of the transportation unit. In yet other examples, more than two transportation units may be mounted to a container.

As shown in FIG. 3B, when hook portions 222 of the gantry system 200 engage the hook-shaped portions 147 of the arms 140, 160, when locating the container in the pipe 300, the hook-shape portions 147 are lifted upwards relative to the rest of the respective arms 140, 160 and the foot portions 149 of the transportation units 100 assume the stowed configuration in which they are tucked into the transportation unit 100. The hook portions 222 of the gantry system may be moved towards each other to engage the hook-shaped portions 147 of the transportation unit 100. If these foot portions 149 were left in the deployed configuration, the foot portions 149 would get caught on the rails 320 on the pipe network. As previously mentioned, instead of tucking the foot portions in, the wheels of the transportation units could be made smaller so that the wheels and the rails on which the wheels are positioned can be pushed further outwardly towards the walls of the pipe, horizontally away from the elongate power supply tracks.

FIG. 3C shows the container 900 being successfully located in the pipe 300 with the foot portions 149 of the transportation units 100 still in the stowed configuration. At this position, the foot portions 149 have successfully cleared the rails 320 in the pipe and the wheels 143 of the transportation units 100 are above the respective rails 320 in the pipe.

FIG. 3D shows the hook portions 222 of the gantry system 200 being moved outwardly away from the container 900 to disengage the hook-shaped portions 147 of the transportation units 100 and allow the transportation assembly with the container 900 mounted thereon to rest on the rails 320 in the pipe 300. In a preferred example, the hook portions 222 are pneumatically driven outwardly to disengage the hook-shaped portions 147. As a result, the hook-shaped portions 147 of the transportation unit 100 will return to their lowered position which, in turn, will cause the foot portions 149 to assume the deployed configuration and contact the elongate power supply track 340. Once the foot portions 149 contact the elongate power supply track, the foot portions 149 receive power from the elongate power supply tracks which is supplied to the motor arrangement 145 to drive the wheels 145 of the transportation units 100. This causes the container 900 with the mounted transportation units 100 to move along the pipe 300 and, in doing so, clearing the hook portions 220 of the gantry system 200. The hook portions of the gantry system can then be moved or positioned away from the pipe.

FIG. 3E shows the container 900 once deployed in the pipe 300 with the transportation units 100 mounted thereon after passing the gantry stage.

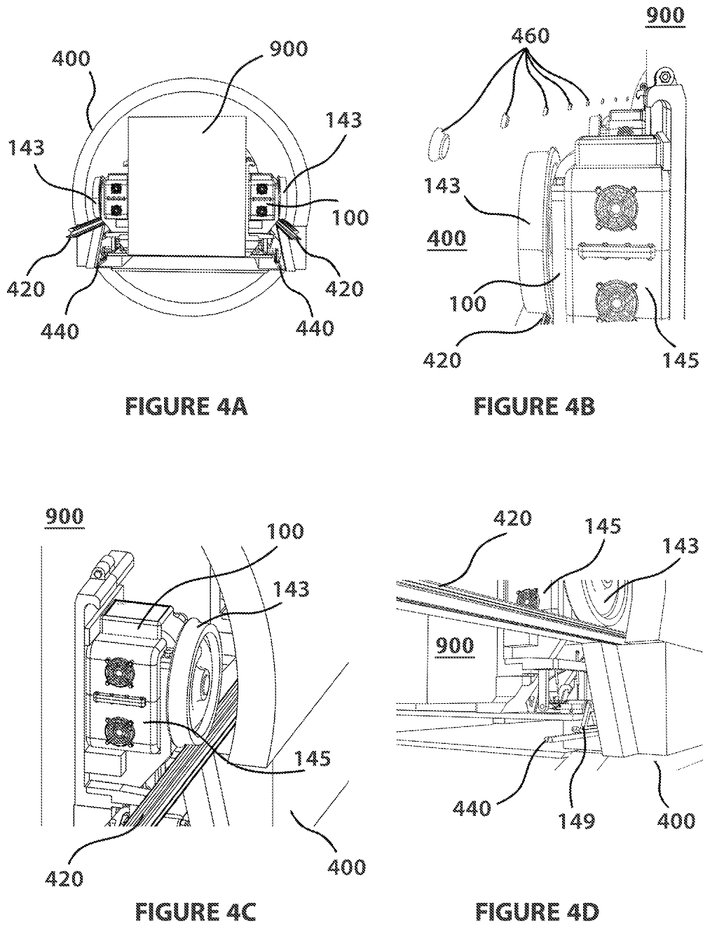

FIGS. 4A to 4D show a pipe 400 of the transportation system according to a preferred embodiment of the present invention and a container 900 with mounted transportation units 100 thereon. The pipe 400 in this embodiment is a cylindrical pipe or a full pipe. Unless otherwise described, the features of the pipe 400 of this embodiment are similar to those features of the pipe 300 previously described with reference to FIGS. 3A to 3E. The pipe 400 according to FIG. 4A to 4D includes a pair of spaced apart rails 420 and a pair of spaced apart elongate power supply tracks 440 below the rails 420. When the container 900 is located in the pipe 400, there is a clearance of at least about 30 cm from the sidewall portions of the pipe 400 to the container 900. The clearance is measured from an upper wall of the container to the pipe inner pipe wall. Preferably, the clearance is at least about 20 cm. The clearance is a function of the pipe curvature of the pipe arrangement in the transportation system. The minimum clearance is based on minimum possible radius of curvature of the pipe.

With reference to FIG. 4B, the pipe 400 includes a sensor arrangement 460 for detecting a location of the container 900 within the pipe 400. In this example, the transportation units 100 have an RFID reader and an internal wall of the pipe 400 has a plurality of spaced apart RFID tags that are detectable by the RFID reader. The location of the container 900 mounted on the transportation units 100 in the pipe 400 can be determined based on the RFID tag reading by the RFID reader. In particular, each RFID tag can be calibrated to provide precise information relating to a location in the pipe 400. The sensor arrangement 460 is included in a housing of the motor arrangement 145 of the transportation unit.

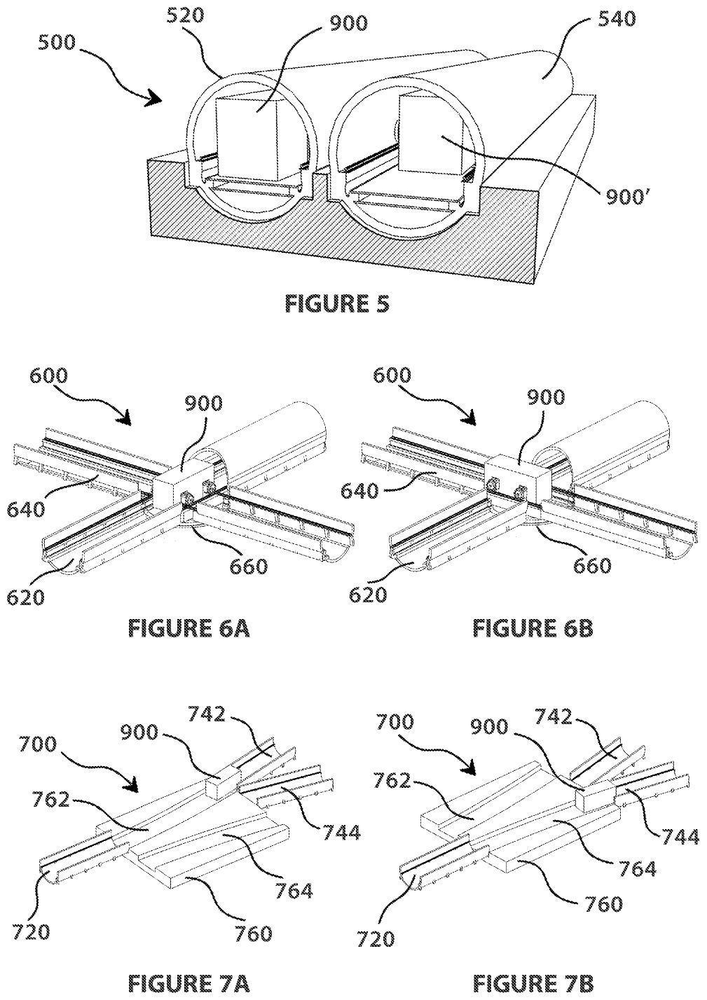

FIG. 5 show a pipe arrangement 500 according to an embodiment of the present invention. The pipe arrangement 500 includes a first pipe 520 and a second pipe 540 that are parallel with each other. The first pipe 520 is for a flow of containers in a first direction, while the second pipe 540 for a flow of containers in a second direction opposite to the first direction. Each pipe 520, 540 is similar to the pipe 400 previously described with reference to FIGS. 4A to 4D. In the preferred example, the first and second pipes 520, 540 are arranged side-by-side, along a horizontal axis. In other examples, the first and second pipes may be arranged along a vertical axis. In other examples, the first pipe may be for conveying containers at a first speed, while the second pipe is for conveying containers at a second speed. In other embodiments, the pipe arrangement may include more than two pipes. The pipe arrangement may include one or more return pipes for conveying transportation units for mounting to a container for transportation through one of the at least two pipes. The return pipe(s) may be parallel with, and adjacent to, the two pipes. The return pipe(s) may span a partial length of the first and second pipes. In yet further examples, one pipe could include more than one pair of rails for allowing more than one container flow path through the pipe. For example, one pipe could allow for two container flow paths, three container flow paths, or four or more container flow paths therethrough.

FIGS. 6A and 6B show a pipe arrangement section 600 for changing a direction of travel of a container 900 through a first pipe 620 to a second pipe 640 that is perpendicular to the first pipe. The pipe arrangement includes a platform 660 that is located at an intersection between the first and second pipes 620, 640. The platform 660 has a pair of rails and elongate power supply tracks that are alignable with the pair of rails and elongate power supply tracks in the first and second pipes 620, 640. The platform 660 is rotatable relative to the first and second pipes 620, 640 between a first position in which the rails and elongate power supply tracks of the platform 660 are aligned with the rails and elongate power supply tracks of the first pipe and a second position in which the rails and elongate power supply tracks of the platform 660 are aligned with the rails and elongate power supply tracks of the second pipe 640. When a container 900 travelling along a first pipe 620 reaches the platform 660, the container would stop on the platform and the platform, upon detecting a container 900 thereon, would rotate from the first position by about 90° to the second position to align the rail and tracks on the platform with the rails and tracks on the second pipe 640. Once aligned, the container 900 would travel along the perpendicular second pipe. In other examples, there may be one or more other pipes at different angles to the first pipe from which the container is conveyed and the platform is rotatable to one or more other positions to align with the rails and tracks of the respective one of the one or more other pipes. For example, the one or more rails could include rails that are between about 10° and 80° to the first pipe 620. In other examples, in addition to being rotatable or instead of being rotatable, the platform may be adjustable vertically relative to the first pipe to locate the container on a different pipe at a different elevation to the first pipe.

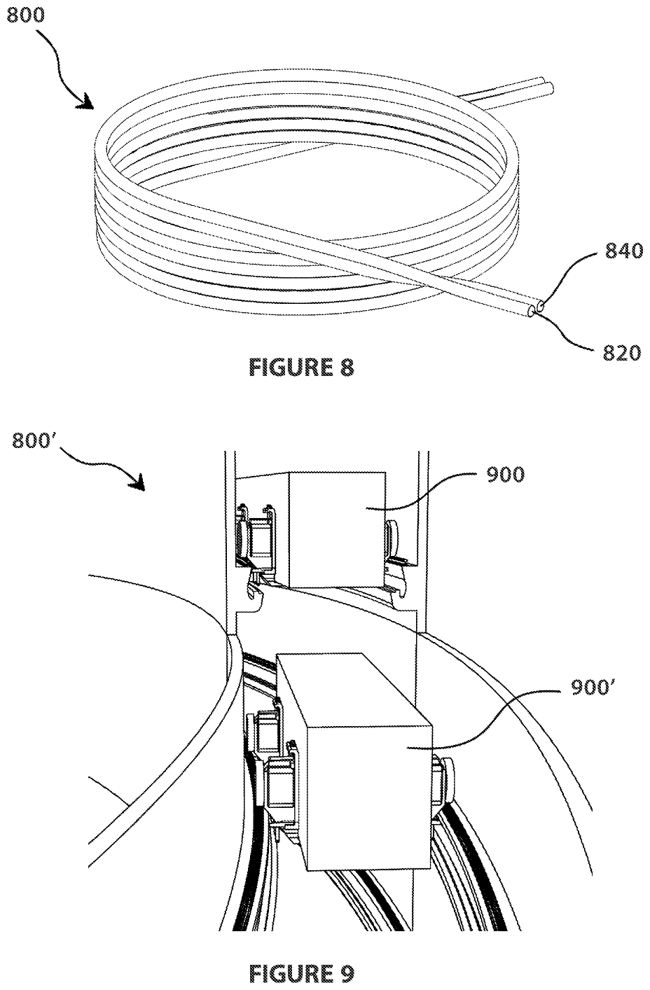

FIGS. 7A and 7B show another pipe arrangement section 700 for changing a direction of travel of a container along a first path through a first pipe 720 along one second pipe 742 or third pipe 744. In this embodiment, the second pipe 742 and the third pipe 744 are at an angle to each other. In this example, the second pipe 742 is angled by about 15° to the third pipe 744. In other examples, the second pipe may be angled at any angle between 10° to 80° to the third pipe. In yet further examples, there may be more than two pipes, at different angles, along which the container from the first pipe may be conveyed. The pipe arrangement section 700 has a platform 760 with two paths 762, 764. A flow path of the container through a first flow path 762 of the platform is at an angle to a second flow path 764 of the platform. The angle between the first and second flow paths 762, 764 corresponds to the angle between the second and third pipes 742, 744. The platform 760 is laterally moveable relative to the incoming first pipe 720 and two outgoing pipes 742, 744. Each path 762, 764 of the platform 760 is parallel to and alignable with a respective one of the outgoing pipes 742, 744. Each path 762, 764 of the platform 760 has a pair of rails and elongate power supply tracks that are alignable with the incoming first pipe 720 and a respective one of the outgoing second or third pipes 742, 744. The platform 760 is adjusted accordingly depending on whether the container 900 from the incoming pipe 720 is desired to be conveyed down the first outgoing pipe 742 (shown in FIG. 8A) or down the second outgoing pipe 744 (shown in FIG. 8B). The time taken for the platform 760 to be adjusted between a first position in which one path 762 is aligned with one of the outgoing pipes 742 and a second position in which the other path 764 is aligned with the other outgoing pipe 744 corresponds substantially to a time for the container to travel from one end of the platform to the other end of the platform. Thereby, when the container is desired to be conveyed from the incoming pipe 720 to one of the outgoing pipes the container 900 transported in a continuous, uninterrupted, flow from the ingoing pipe, along the platform 760 as it is adjusted to the appropriate position, to the desired outgoing pipe.

FIG. 8 shows a pipe arrangement with a first pipe 820 and a second pipe 840 in a helical arrangement for varying an elevation along which the containers are conveyed. In the helical arrangement, the first and second pipes 820, 840 are spirally arranged to define one or more loops. Prior to the helical arrangement, the first and second pipes 820, 840 are arranged side-by-side to each other, along a horizontal plane. At a section of the arrangement, the second pipe 840 slopes downwardly and inwardly towards the first pipe to be located below the first pipe 820 such that first and second pipes 820, 840 are vertically aligned (or arranged along a vertical plane). The first and second pipes 820, 840 are arranged in a helical pattern where they spiral vertically. At the lower end of the helix arrangement, the second pipe 840 is sloped upwardly and outwardly from the first pipe 820 to relocate the second pipe 840 to be side-by-side to the first pipe 820. The number of loops of the first and second pipes in the helix arrangement may vary. In the example shown helix arrangement of pipes has three loops or circuits. In other examples, the helix arrangement may have less than 3 loops or more than 3 loops. The helix arrangement provides a curved portion through which the container is passable, the curved portion having a radius of at least 70 m. Preferably, the curved portion has a radius of at least 90 m. The pipe arrangement may include a sloping pipe portion for changing an elevation of the containers conveyed through the pipe arrangement. The sloping pipe portion may have a gradient of at least about 1%. The gradient of the incline may be about 10%. The gradient is chosen such that the elevation drops by at least twice the nominal pipe diameter on each circuit around the circumference of the helix. The pipe arrangement may include a helix arrangement of pipes.

FIG. 9 shows a pipe arrangement 800′ with a helix section according to another embodiment of the present invention. In this example, the helix section of the pipe arrangement 800′ is defined by a shell 802 of the pipe arrangement 800′ through which containers 900, 900′ can be conveyed. The rails and elongate power supply tracks along which the containers are conveyed are helically arranged within the shell. There are no internal walls within the shell 802 (i.e. upper or lower walls) that separate the flow paths of the containers thorough the helical section. In some embodiments, no separating walls or panels partition the flow paths of the containers through the helical section.

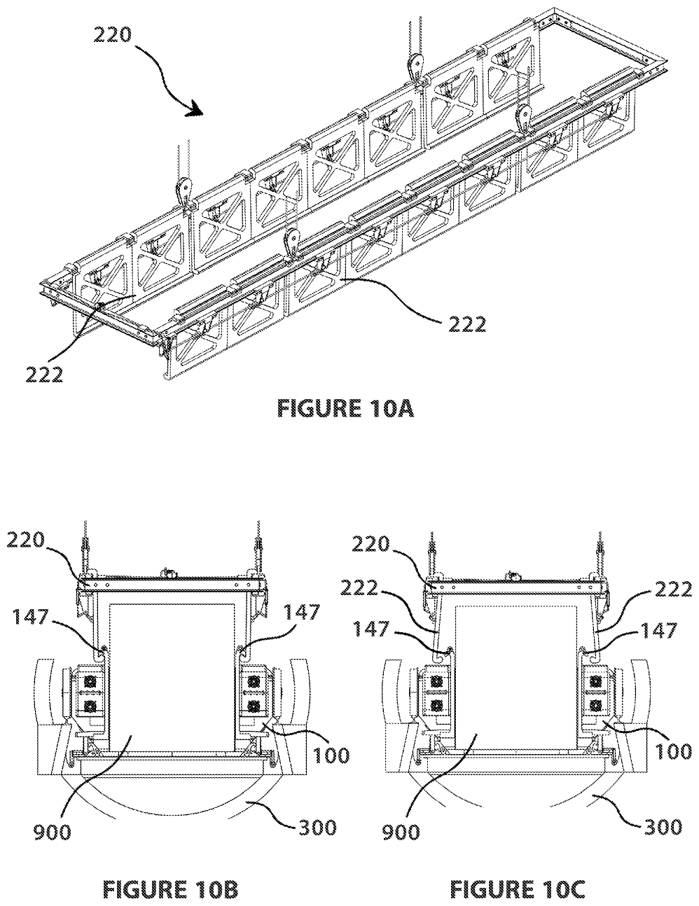

FIGS. 10A to 10C show a gantry component 220 according to an embodiment of the present invention for lifting one or more transportation units from a pipe 300 and for locating one or more transportation units 100 in the pipe 300. The gantry component 220 is a grappler that is coupled to a gantry system. The gantry component 220 can be laterally and vertically adjusted by the gantry system. The gantry component 220 has a pair of hook portions 222 for engaging hook-shaped portions 147 of the transportation unit 100 as previously described above. The hook portions are arranged on opposite sides of the gantry component. The hook portions 222 are adjustable between a clamping configuration (shown in FIG. 10B) in which the hook portions 222 are adjusted inwardly towards each other to engage the hook-shaped portions 147 of the transportation unit and a release configuration (shown in FIG. 10C) in which the hook portions are adjusted outwardly away from each other to disengage the hook-shaped portions 147 thereby releasing the transportation unit 100. The gantry component 220 is provided with a hydraulic or pneumatic component for adjusting the position of each arm between the clamping configuration and the release configuration. The hook portions 222 are one example of an engaging component, or an engaging mechanism, for engaging the transportation unit for securely carrying the transportation unit to or from a pipe. Other suitable engaging components could be employed to engage the transportation units. In addition, the hook shaped portions 220 on each side of the gantry component include a plurality of hook sections that are adjustable independently of other sections in the portion. Two or more hook sections of each portion may be independently actuatable from their respective release configuration to their respective clamping configuration depending on the length of the container to be conveyed in the pipe. For example, a first hook section at or near a forward end of the gantry component may be adjusted from a release configuration to a clamping configuration to securely receive a first transportation unit at a first location along a length of the gantry component 220 and a second hook section at or near a rearward end of the gantry component may be adjusted from a release configuration to a clamping configuration to securely receive a second transportation unit at a second location along the length of the gantry component 220. The distance from the first location to the second location at least about 75% the length of the container to be mounted onto by the first and second transportation units 100.

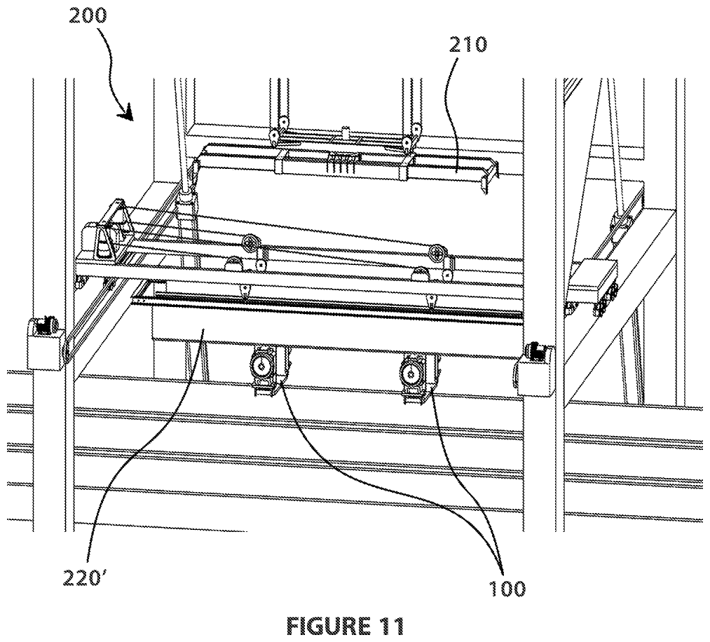

FIG. 11 shows a gantry system 200 according to an embodiment of the present invention. The gantry system 200 includes a first gantry 210 for carrying a container from a platform. The gantry system 200 further includes a second gantry with a gantry component 220′ that is similar to the gantry component 220 described previously with reference to FIGS. 10A to 10C. The second gantry with the gantry component 220′ is for carrying one or more transportation units to which a container is mounted. The gantry system 200 includes a controller that is configured to align the first gantry and the second gantry with each other so as to mount the container carried by the first gantry onto the transportation units carried by the second gantry for subsequent positioning into a respective one of the pipes. The second gantry with the gantry component 220′ is configured or adapted to pluck (or collect) the transportation unit from a return pipe or a service pipe. In other examples, the gantry system may include a gantry for locating a container onto one or more transportation units in a pipe without having to remove the one or more transportation units from the pipe.

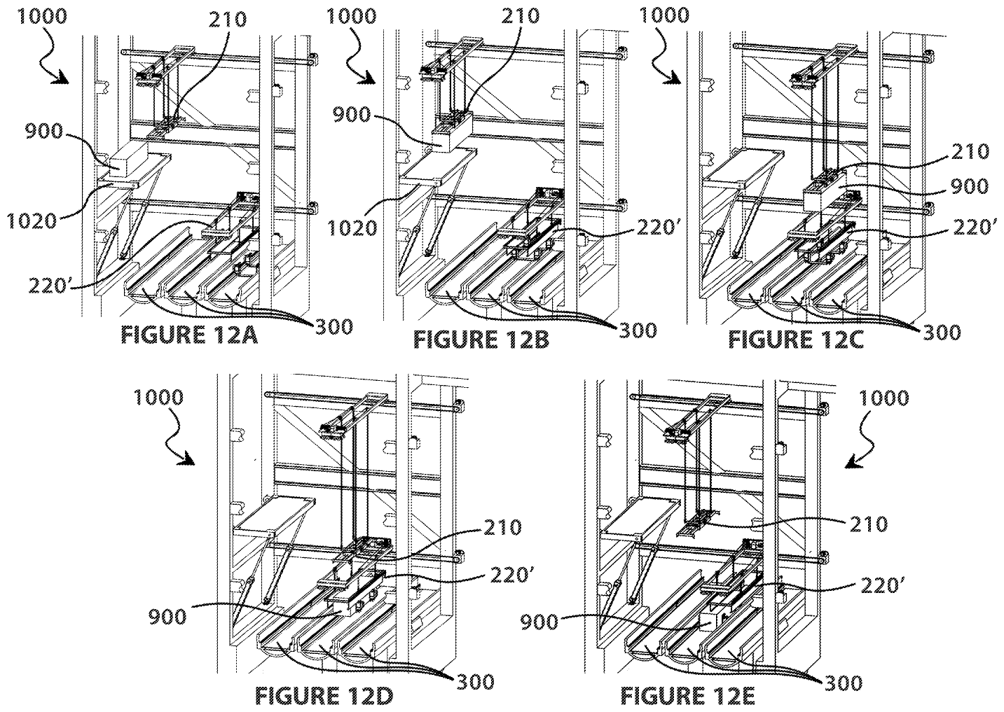

FIGS. 12A to 12E illustrate a transportation system 1000 with the gantry system 200 previously described for locating a container 900 in a pipe. The pipe 300 is a partial pipe described previously with reference to FIGS. 3A to 3E. The transportation system 1000 in this example has a pipe arrangement having three pipes 300. A first one of the pipes is for conveying containers in a first direction, while a second one of the pipes is for conveying containers in a second direction, opposite to the first direction. The third pipe is a return pipe, or service pipe, for delivering transportation units for mounting to the container. The first and second pipes may span a length from a shipping dock to a storage facility, while the third pipe spans a partial length of the first and second pipes. For example, the third pipe may run from a transportation storage facility that is located at or near the gantry system 200.

With reference to FIG. 12A, a primary gantry (not shown) locates the container 900 to be conveyed on a platform 1020. With reference to FIG. 12B, the first gantry 210 of the gantry system collects the container 900 from the platform 1020, while the second gantry with the gantry component 220′ collects two transportation units 100 from the third pipe and locates the transportation units above the second pipe in which the container 900 is to be conveyed. As shown in FIG. 12C, the controller of the gantry system aligns the first gantry 210 with the second gantry with the gantry component 220′ such that the container that is carried by the first gantry 210 is positioned immediately above the second gantry with the gantry component 220′. With reference to FIG. 12D, the first gantry lowers the container 900 onto the transportation units 100 carried by the second gantry with the gantry component 220′. With reference to FIG. 12E, the second gantry lowers the transportation units 100 with the container mounted thereon into the second pipe. Once in the pipe, the gantry component 220 of the second gantry disengages the transportation units, which causes the foot portions of the transportation units to assume the deployed configuration as previously described in which they contact the elongate power supply tracks such that the motor arrangement receives power from the elongate power supply track to drive the wheels of the transportation units to propel the container through the pipe.

The previous paragraphs describe the process of mounting a container to one or more transportation units with the gantry system. The gantry system can be operated in reverse to remove the transportation units from a container. For example, in the process of receiving a container from the pipe arrangement, the second gantry with the hook portions are arranged to engage the hook-shaped portions of the transportation units with the container mounted thereon in a pipe and to lift the transportation units with the container out of the pipe. The first gantry then engages the container and removes container from the transportation units. The second gantry then positions the transportation units in a service pipe or holds the transportation units for mounting to a container.

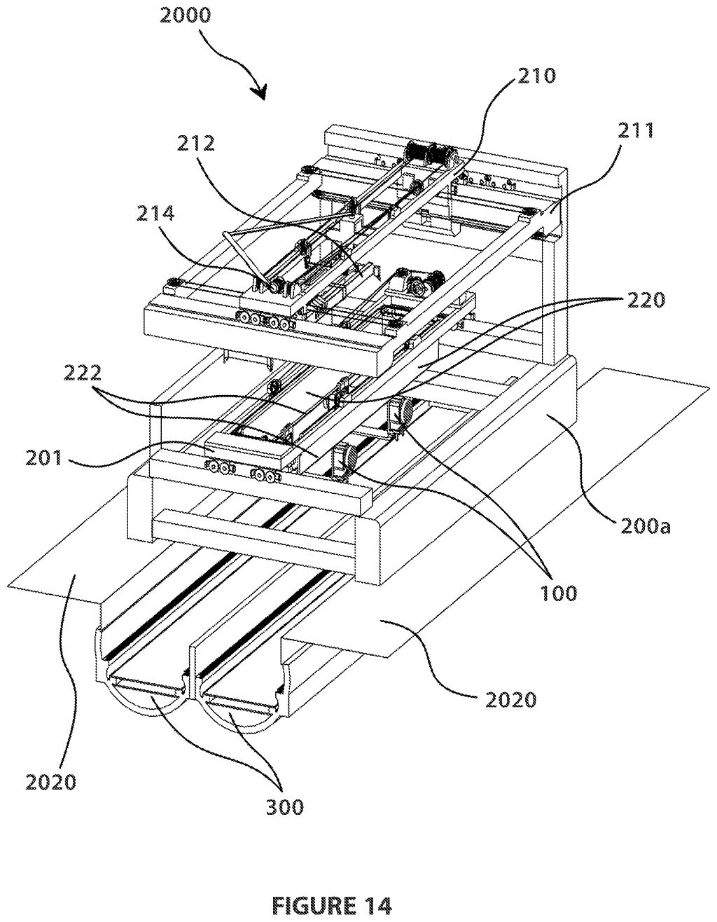

FIG. 14 illustrates another embodiment of a transportation system 2000 with a gantry system 200a that is a mobile structure. The gantry system 200a includes a first gantry 210 and a second gantry 201. Gantry system 200a may be particularly adapted for use at the end of the transportation system 2000, while gantry system 200 may be particularly adapted for use at the beginning of the transportation system 1000. That is, the gantry system 200 may be particularly suited to use at a dock, while the gantry 200a may be particularly suited to use at a transfer station at which containers might be transferred to conventional road or rail freight transportation or to a storage facility.

The pipe 300 is a partial pipe described previously with reference to FIGS. 3A to 3E. The transportation system 2000 in this example has a pipe arrangement having two pipes 300. A first one of the pipes may be for conveying containers in a first direction, while the second one of the pipes may be for conveying containers in a second direction, opposite to the first direction. Alternatively, a first one of the pipes may be for conveying containers in a first direction, while the second one of the pipes may be a service pipe for returning transportation units (from which the containers have been detached) back for reuse. The first and second pipes may span a length from a shipping dock to the gantry 200a.

The second gantry 201 collects two transportation units 100, from which the container is to be removed or to which the container will be provided, from one pipe 300 and locates the transportation units 100 into the other pipe 300. The second gantry 201 includes a gantry component 220. The gantry component 220 is a grappler that is coupled to a gantry system 200a. The gantry component 220 can be laterally and vertically adjusted by the gantry system. The gantry component 220 has a pair of hook portions 222 for engaging hook-shaped portions 147 of the transportation unit 100 as previously described above. The hook portions are arranged on opposite sides of the gantry component. The hook portions 222 are adjustable between a clamping configuration (shown in FIG. 14) in which the hook portions 222 are adjusted inwardly towards each other to engage the hook-shaped portions 147 of the transportation unit and a release configuration (not shown) in which the hook portions are adjusted outwardly away from each other to disengage the hook-shaped portions 147 thereby releasing the transportation unit 100. The gantry component 220 is provided with a hydraulic or pneumatic component for adjusting the position of each arm between the clamping configuration and the release configuration. The hook portions 222 are one example of an engaging component, or an engaging mechanism, for engaging the transportation unit for securely carrying the transportation unit to or from a pipe. As described above, other suitable engaging components could be employed to engage the transportation units.

When a container is being removed from the transportation units 100, the second gantry 201 will first lift the transportation units 100, with the container in situ, out of the pipe 300. The first gantry 210 of the gantry system 200a may collect a container (not shown) from, or deposit a container to, the ground surface 2020. The upper (first) gantry 210 uses a spreader 212, which can be raised and lowered as necessary, to collect the container from the transportation units 100 that have been lifted out of the pipe by the second gantry 201.

The first gantry 210 can be positioned along the sliding arm 211 using the platform positioning motor 215, as well as by moving the sliding arm 211, so as to align the gantry with the first or second pipe to collect or deposit the container. In addition, the sliding arm 211 can shift the first gantry 210 out over the ground surface 2020 on either side of the gantry system 200a, and the spreader 212 can be lowered to move the container onto the ground surface 2020 or onto an awaiting transportation device (not shown), such as conventional road or rail freight transportation.

While the container is being lowered to the ground 2020 by the first gantry 210, the second gantry can return the transportation units to the original pipe or transfer them to the other pipe. Once the transportation units 100 are positioned in the pipe, the gantry component 220 of the second gantry disengages the transportation units 100, which causes the foot portions of the transportation units to assume the deployed configuration as previously described in which they contact the elongate power supply tracks such that the motor arrangement receives power from the elongate power supply track to drive the wheels of the transportation units.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

1. A transportation unit for a container, the transportation unit having:
a wheel arrangement including wheels for engaging a rail along which the container is conveyable, each wheel being locatable at a side of the container;
a chassis on which the container to be conveyed is located, and
arms extending from opposite sides of the chassis,
wherein said unit is detachably mounted to the container,
wherein said unit is an independent vehicle that can be controlled and managed without any connection to the container, and
wherein the arms are pivotable inward relative to the chassis as the container is being located on the chassis so as to clamp the container between the arms of the chassis and thereby locate the wheels on the container.

2. The transportation unit of claim 1, wherein the wheel arrangement includes two or more first wheels that are attachable to a first sidewall of the container and two or more second wheels that are attachable to a second opposite sidewall of the container.

3. The transportation unit of claim 2, wherein each of the first wheels and each of second wheels are respectively mounted at or near a mid-height of the container.

4. (canceled)

5. The transportation unit of claim 1, wherein one or more arms on each side of the chassis comprise a hook-shaped portion configured to be engageable by engaging portions of a gantry system for carrying the transportation unit.

6. The transportation unit of claim 5, comprising:
a motor arrangement for driving said one or more wheels; and
one or more foot portions electrically connected to the motor arrangement, said one or more foot portions being configured to contact an elongate power supply track to supply power to the motor arrangement.

7. The transportation unit of claim 6, wherein each of said one or more foot portions is connected to one of said hook-shaped portions; wherein each of said hook-shaped portions connected to one of said one or more foot portions is configured:
to raise when engaged by the engaging portions and thereby move the foot portion connected thereto into a stowed configuration, wherein in the stowed position the foot portion is disengaged from the elongate power supply track; and
to lower when disengaged from the engaging portions and thereby move the foot portion connected thereto into a deployed configuration for contacting the elongate power supply track.

8. (canceled)

9. (canceled)

10. (canceled)

11. A transportation system for containers, the system comprising: at least one rail-based conveyance arrangement for conveying containers, said arrangement having rails and being adapted or configured to engage a transportation unit according to claim 1, said arrangement being adapted or configured to allow a container to pass therethrough.

12. The transportation system of claim 11, wherein the rail-based conveyance arrangement is a pipe arrangement that includes a pipe having a width, and rails on which the transportation unit for conveying the container is mounted, each rail being positioned on opposite sides of the pipe wherein a distance between the rails substantially corresponds to the width of the pipe.

13-21. (canceled)

22. The transportation system of claim 11, wherein the rail-based conveyance arrangement includes a service conveyance flow-path for conveying the transportation unit to another conveyance flow-path along which a container is to be conveyed by said transportation unit.

23. The transportation system of claim 22, wherein the rail-based conveyance arrangement is a pipe arrangement and the service conveyance flow-path and the other conveyance flow-path are each defined by a pipe.

24. The transportation system of claim 11, wherein the rail-based conveyance arrangement includes a sloping portion for changing an elevation of the containers conveyed through the rail-based conveyance arrangement.

25. (canceled)

26. The transportation system of claim 11, wherein the rail-based conveyance arrangement includes first and second flow-paths arranged in a vertically-spiralling helical pattern.

27. The transportation system of claim 11, wherein the rail-based conveyance arrangement and the transportation unit includes a sensor arrangement for determining a location of the transportation unit within the rail-based conveyance arrangement.

28. The transportation system of claim 27, wherein the sensor arrangement includes one or more RFID tags and one or more RFID readers for reading the RFID tags.

29. The transportation system of claim 28, wherein the RFID tags are provided along a length of the rail-based conveyance arrangement and the RFID reader for reading the RFID tags is provided on the transportation unit.

30. The transportation system of claim 11, wherein the transportation system includes a power supply system for powering said transportation unit when said transportation unit is mounted to one of the containers for conveying the container through the rail-based conveyance arrangement, wherein the power supply system includes an elongate track that spans a length of the rail-based conveyance arrangement.

31. (canceled)

32. The transportation system of claim 30, wherein the rail-based conveyance arrangement is a pipe arrangement, and the elongate track is located in the pipe arrangement at an elevation below the rails of the rail-based conveyance arrangement.

33. (canceled)

34. (canceled)

35. (canceled)

36. A gantry system for a container transportation system in which containers are transported via a rail-based conveyance arrangement, the gantry system including:
a first gantry for carrying one of the containers to or from a platform,
a second gantry for carrying a transportation unit according to claim 1, said transportation unit being detachably mountable to the container, and
a controller for aligning the first gantry and the second gantry with each other so as to mount the transportation unit onto the container or to unmount the transportation unit from the container.

37. The gantry system of claim 36, wherein the controller is configured to align the first and second gantries with a conveyance flow-path of the rail-based conveyance arrangement in which the container is to be conveyed.

38. (canceled)

39. The gantry system of claim 36, wherein the second gantry is configured or adapted to pluck the transportation unit from a service conveyance flow-path.

40. (canceled)
